(19) United States
(12) Patent Application Publication
(10) Pub. No.: US 2003/0043975 A1
(43) Pub. Date: Mar. 6, 2003

(54) Voicemail/memo service

(75) Inventors: Kulvir Singh Bhogal, Fort Worth, TX (US); Nizamudeen Ishmael JR., Austin, TX (US); Javid Jameossanaie, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/942,796

(22) Filed: Aug. 30, 2001

(51) Int. Cl. H04M 11/00

(52) U.S. Cl. 379/88.14

(57) ABSTRACT

A method, program and system for entering messages into a database are provided. The method comprises accessing the database by means of one of a plurality of allowable communication devices, which may include phone, mobile phone, PDA, pager and computer. The user then enters a voice or text message into a designated account in the database. The message is stored in a uniform format, which is specified for the account. This uniform format is independent of the communication device used to access the database. When messages are retrieved from the database, the messages are converted from the uniform format into a format which is compatible with the device used to access the database.

### BACKGROUND OF THE INVENTION

1. Technical Field

The present invention relates generally to telecommunication and computer networks, and more specifically to remote message retrieval.

2. Description of Related Art

For busy individuals, it is often convenient to leave voice messages or memos to oneself. Currently, there are small devices that provide such functions, such as miniature tape recorders. Many people also create their own adhoc memo systems by calling their own telephone answering machines or telephone voicemail accounts and leaving messages to themselves.

Some companies offer special memo services in which a user calls a designated call center and leaves a voice message in his or her personal account. Unfortunately, such voicemail/memo services are limited and scope, as they do not provide a wide range of services to the same user. For example, current remote access memo services are usually limited to voice messages recorded via telephone and do not allow entry and retrieval via devices employing Transmission Control Protocol/Internet Protocol (TCP/IP). In addition, current memo services do not allow the account holder to leave public messages, which third parties may access.

Therefore, it would be desirable to have a method for recording and retrieving personal memos from a central location that can be accessed via both telephone and IP communication, and also allows the recording of a message to and from parties other than the account holder.

### SUMMARY OF THE INVENTION

The present invention provides a method, program and system for entering messages into a database. The method comprises accessing the database by means of one of a plurality of allowable communication devices, which may include phone, mobile phone, PDA, pager and computer. The user then enters a voice or text message into a designated account in the database. The message is stored in a uniform format, which is specified for the account. This uniform format is independent of the communication device used to access the database. When messages are retrieved from the database, the messages are converted from the uniform format into a format which is compatible with the device used to access the database.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a system diagram illustrating a plurality of interconnected heterogeneous networks in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4A depicts a diagram illustrating a mobile phone in accordance with a preferred embodiment of the present invention;

FIG. 4B depicts a block diagram illustrating the hardware configuration of mobile phone 400 in accordance with a preferred embodiment of the present invention;

FIG. 5A depicts a diagram of a client in the form of a personal digital assistant (PDA) in accordance with a preferred embodiment of the present invention;

FIG. 5B depicts a block diagram illustrating the hardware configuration of PDA 500 in accordance with a preferred embodiment of the present invention;

FIG. 6 depicts a schematic diagram illustrating a general overview of the architecture of a voicemail/memo service in accordance with the present invention;

FIG. 7 depicts a flowchart illustrating the process of recording a voice message/memo in accordance with the present invention;

FIG. 8 depicts a flowchart illustrating the retrieval of voicemail/memos in accordance with the present invention; and

FIG. 9 depicts a flowchart illustrating the use of Common Gateway Interface to access voicemail via TCP/IP in accordance with the present invention.

### DETAILED DESCRIPTION OF THE PREFERRED EMBODIMENT

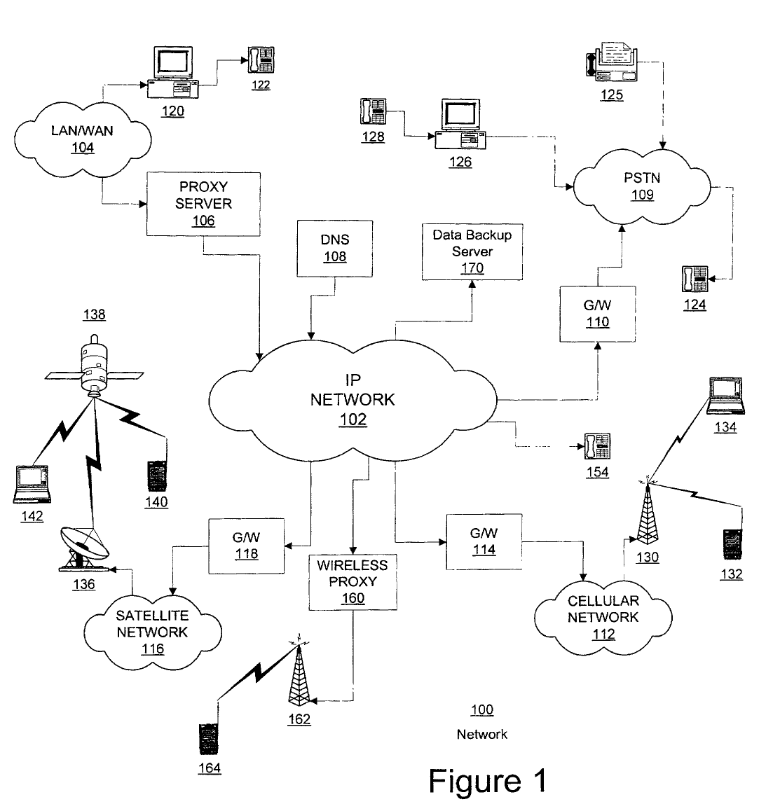

With reference now to the figures, and in particular with reference to FIG. 1, a system diagram illustrating a plurality of interconnected heterogeneous networks in which the present invention may be implemented is depicted. As illustrated, an Internet Protocol (IP) network 102, a Local Area Network (LAN)/Wide Area Network (WAN) 104, the Public Switched Telephone Network (PSTN) 109, a cellular wireless network 112, and a satellite communication network 116 make up the plurality of heterogeneous networks serviced by the present invention.

IP network 102 may be the publicly available IP network, a private IP network, or a combination of public and private IP networks. In any case, IP network 102 operates according to the Internet Protocol and routes packets among its many switches and through its many transmission paths. IP networks are generally known in the art to be expandable, fairly easy to use and heavily supported. Coupled to IP network 102 is a Domain Name Server (DNS) 108 to which queries may be sent, such queries each requesting an IP address based upon a Uniform Resource Locator (URL). IP network 102 supports 32 bit IP addresses as well as 128 bit IP addresses, which are currently in the planning stage.

LAN/WAN 104 couples to IP network 102 via a proxy server 106 (or another connection). LAN/WAN 104 may operate according to various communication protocols, such as the Internet Protocol, the Asynchronous Transfer Mode (ATM) protocol, or other known packet switched protocols. Proxy server 106 serves to route data between IP network 102 and LAN/WAN 104. A firewall that precludes unwanted communications from entering LAN/WAN 104 may also be located at the location of proxy server 106.

Computer 120 couples to LAN/WAN 104 and supports communications with LAN/WAN 104. Computer 120 may employ the LAN/WAN and proxy server 106 to communicate with other devices across IP network 102. Such communications are generally known in the art and will not be further described herein except to expand upon the teachings of the present invention. As is also shown, phone 122 couples to computer 120 and may be employed to initiate IP Telephony communications with another phone or voice terminal using IP Telephony. In such an IP telephony system, a gatekeeper is deployed by a service provider to manage IP telephony for its users. An IP phone 154 connected to IP network 102 (or other phone, e.g., phone 124) may communicate with phone 122 using IP telephony.

PSTN 109 is a circuit switched network that is primarily employed for voice communications, such as those enabled by a standard phone 124. However, PSTN 109 also supports the transmission of data. Data transmissions may be supported to a tone based terminal, such as a FAX machine 125, to a tone based modem contained in computer 126, or to another device that couples to PSTN 109 via a digital connection, such as an Integrated Services Digital Network (ISDN) line, an Asynchronous Digital Subscriber Line (ADSL), or another digital connection to a terminal that supports such a connection. As illustrated, a voice terminal, such as phone 128, may couple to PSTN 109 via computer 126 rather than being supported directly by PSTN 109, as is the case with phone 124. Thus, computer 126 may support IP telephony with voice terminal 128, for example.

Cellular network 112 supports wireless communications with terminals operating in its service area (which may cover a city, county, state, country, etc.). As is known, cellular network 112 includes a plurality of towers, e.g., 130, that each service communications within a respective cell. Wireless terminals that may operate in conjunction with cellular network 112 include wireless handsets 132 and wirelessly enabled laptop computers 134, for example. Wireless handsets 132 could be, for example, personal digital assistants, wireless or cellular telephones, or two-way pagers. Cellular network 112 couples to IP network 102 via gateway 114.

Wireless handsets 132 and wirelessly enabled laptop computers 134 may communicate with cellular network 112 using a wireless application protocol (WAP). WAP is an open, global specification that allows mobile users with wireless devices, such as, for example, mobile phones, pagers, two-way radios, smartphones, communicators, personal digital assistants, and portable laptop computers, to easily access and interact with information and services almost instantly. WAP is a communications protocol and application environment and can be built on any operating system including, for example, Palm OS, EPOC, Windows CE, FLEXOS, OS/2, and JavaOS. WAP provides interoperability even between different device families.

WAP is the wireless equivalent of Hypertext Transfer Protocol (HTTP) and Hypertext Markup Language (HTML). The HTTP-like component defines the communication protocol between the handheld device and a server or gateway. This component addresses characteristics that are unique to wireless devices, such as data rate and round-trip response time. The HTML-like component, Wireless Markup Language (WML), defines new markup and scripting languages for displaying information to and interacting with the user. This component is highly focused on the limited display size and limited input devices available on small, handheld devices. For example, a typical cell phone may have only a 4×10-character display with 16-gray levels and only a numeric keypad in addition to up/down volume keys.

Cellular network 112 operates according to an operating standard, which may be the Advanced Mobile Phone System (AMPS) standard, the Code Division Multiple Access (CDMA) standard, the Time Division Multiple Access (TDMA) standard, or the Global System for Mobile Communications or Groupe Speciale Mobile (GSM), for example. Independent of the standard(s) supported by cellular network 112, cellular network 112 supports voice and data communications with terminal units, e.g., 132 and 134.

Satellite network 116 includes at least one satellite dish 136 that operates in conjunction with a satellite 138 to provide satellite communications with a plurality of terminals, e.g., laptop computer 142 and satellite handset 140. Satellite handset 140 could also be a two-way pager. Satellite network 116 may be serviced by one or more geosynchronous orbiting satellites, a plurality of medium earth orbit satellites, or a plurality of low earth orbit satellites. In any case, satellite network 116 services voice and data communications and couples to IP network 102 via gateway 118.

Wireless Proxy 160 is coupled to IP network 102 and is coupled to a plurality of towers, e.g., 162, which each provide wireless communications with wireless devices such as wireless device 164. Wireless Proxy 160 provides access to IP network 102 to wireless device 164, such as a personal digital assistants (PDA) or a wireless telephone, that may require proprietary or other special protocols in order to communicate with IP network 102. For example, wireless proxy server 160 may be a 3Com server utilizing 3Com protocols for communicating with a Palm VII, a handheld portable computing device available from 3Com Corporation in Santa Clara, Calif.

In a preferred embodiment of the present invention, wireless proxy 160 is a 3Com proxy server supporting communications with a Palm VII personal organizer and portable computing device 164 is a Palm VII personal organizer. In this embodiment, communications between wireless proxy server 160 and portable computing device 164 is facilitated by the use of Palm Query Applications (PQAs). A PQA is like a mini-Web site that resides on portable computing device 164. That is, a PQA is a special kind of record database. A typical PQA contains an HTML form or a list of hyperlinks that request additional information either locally—on personal computing device 164—or remotely—on the Internet.

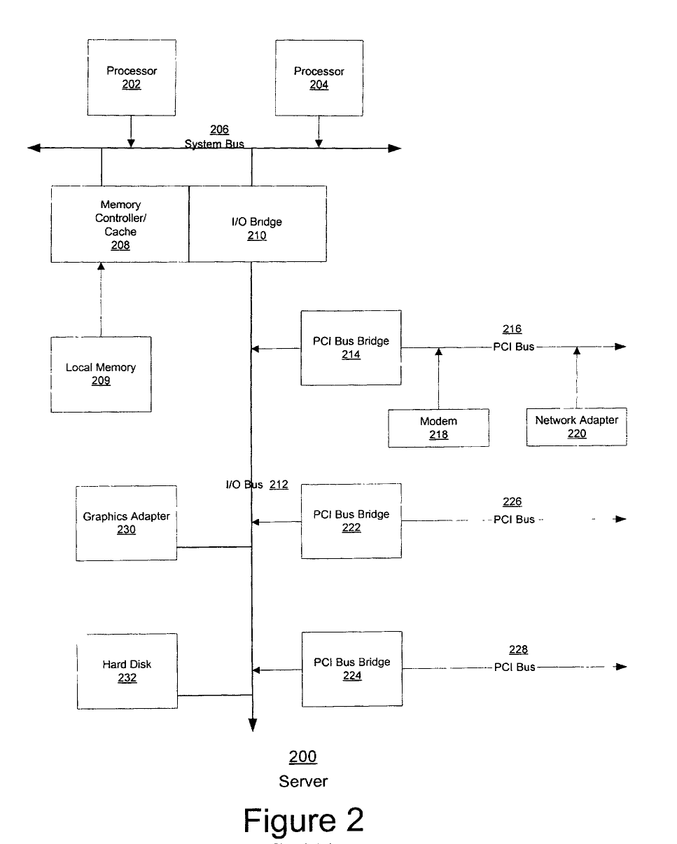

Referring to FIG. 2, a block diagram of a data processing system that may be implemented as a server is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

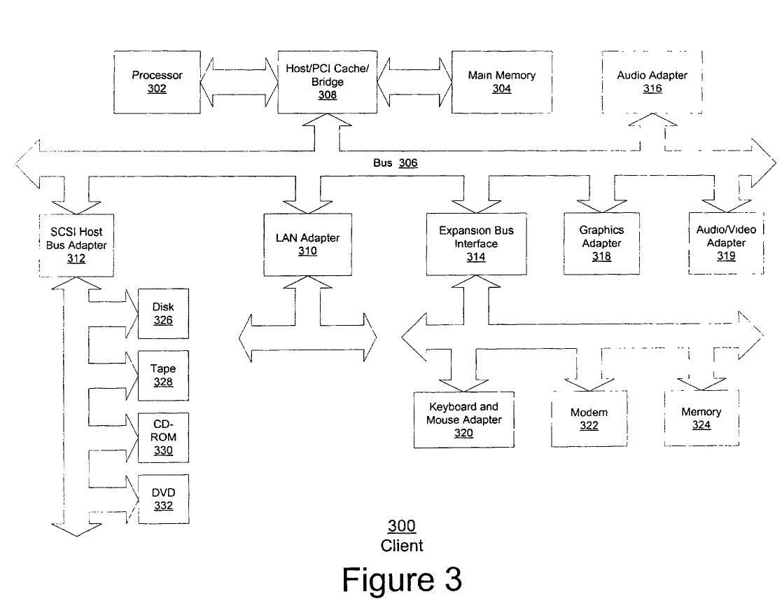

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

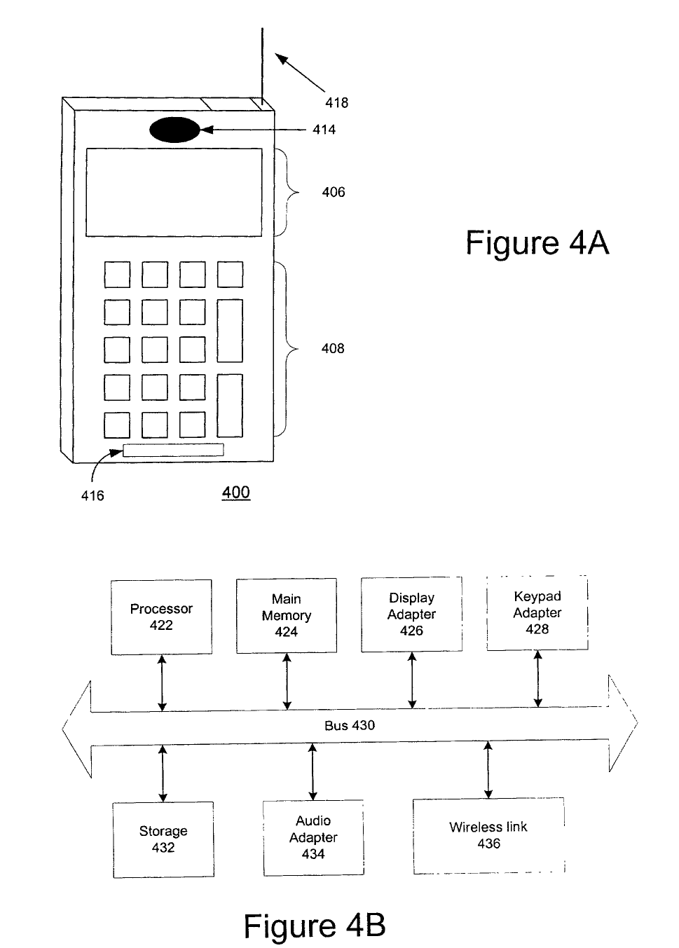

With reference now to FIG. 4A, a diagram illustrating a mobile phone is depicted in accordance with a preferred embodiment of the present invention. Mobile phone 400 includes a display 406 for presenting textual and graphical information. Display 406 may be a known display device, such as a liquid crystal display (LCD) device.

Mobile phone 400 may also include keypad 408, speaker 414, and microphone 416. The keypad may be used to enter, for example, telephone numbers, user identification information, and commands for interacting with the interface. Audio feedback may be presented via speaker 414. In addition to normal voice conversation, feedback may include other information, for example, an audio description of user location (as determined by positioning technologies). And microphone 416 can be used not only for voice conversation, but for entering specific voice commands for voice actuated functions.

Mobile phone 400 also includes antenna 418, which is necessary for establishing wireless communication links with remote transmitting towers.

Turning now to FIG. 4B, a block diagram illustrating the hardware configuration of mobile phone 400 is shown in accordance with a preferred embodiment of the present invention. FIG. 4B illustrates the increasing sophistication of modern mobile phone designs.

Mobile phone 400 employs bus architecture. Processor 422 and main memory 424 are connected to bus 430. Display adapter 426, keypad adapter 428, storage 432, and audio adapter 434 are also connected to bus 430. Mobile phone 400 also includes wireless link 436 connected to bus 430. Those of ordinary skill in the art will appreciate that the hardware in FIG. 4B may vary depending on the implementation. Other internal hardware or peripheral devices may be used in addition to or in place of the hardware depicted in FIG. 4B.

Mobile phone 400 might rely on Wireless Application Protocol (WAP) for facilitating communications. WAP is a standard for providing wireless phones, pagers and other handheld devices with secure access to e-mail and text-based Web pages. WAP provides a complete environment for wireless applications that includes a wireless counterpart of TCP/IP and a framework for telephony integration such as call control and phone book access. WAP features the Wireless Markup Language (WML), which was derived from Phone.com's HDML and is a streamlined version of HTML for small screen displays. It also uses WMLScript, a compact JavaScript-like language that runs in limited memory. WAP also supports handheld input methods such as a keypad and voice recognition. Independent of the air interface, WAP runs over all the major wireless networks in place. It is also device independent, requiring only a minimum functionality in the unit so that it can be used with a myriad of phones and handheld devices.

The depicted example in FIG. 4B and above-described examples are not meant to imply architectural limitations.

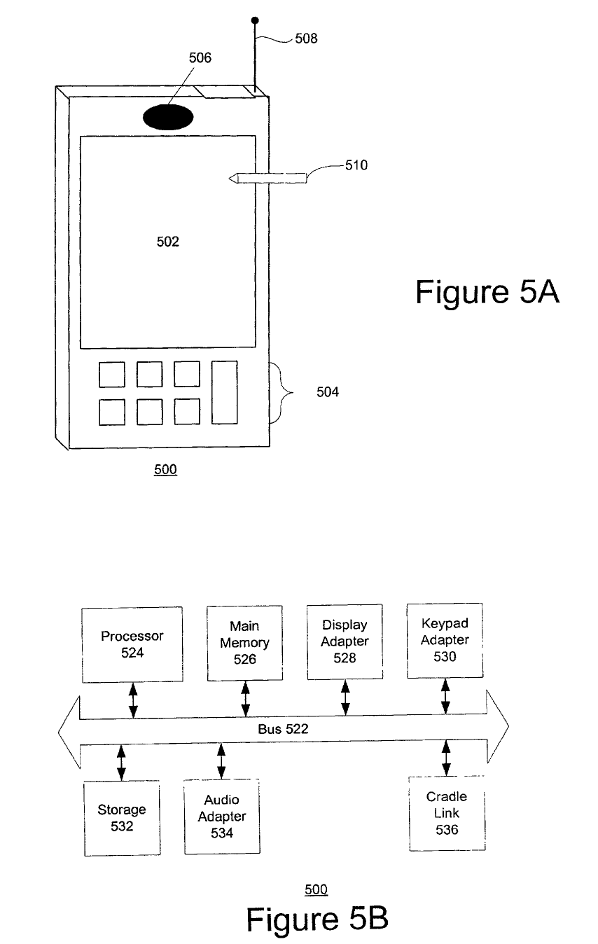

With reference now to FIG. 5A, a diagram of a client in the form of a personal digital assistant (PDA) is depicted in accordance with a preferred embodiment of the present invention. PDA 500 includes a display 502 for presenting textual and graphical information. Display 502 may be a known display device, such as a liquid crystal display (LCD) device. The display may be used to present a map or directions, calendar information, a telephone directory, an electronic mail message, etc. In these examples, screen 502 may receive user input using an input device such as, for example, stylus 510.

PDA 500 may also include keypad 504, speaker 506, and antenna 508. Keypad 504 may be used to receive user input in addition to using touch screen 502. Speaker 506 provides a mechanism for audio output, such as presentation of an audio file. Antenna 508 provides a mechanism used in establishing a wireless communications link between PDA 500 and a network, such as network 100 in FIG. 1.

PDA 500 also preferably includes a graphical user interface that may be implemented by means of systems software residing in computer readable media in operation within PDA 500.

Turning now to FIG. 5B, a block diagram illustrating the hardware configuration of PDA 500 is shown in accordance with a preferred embodiment of the present invention. PDA 500 is an example of a PDA in which code or instructions implementing the processes of the present invention may be located. PDA 500 includes a bus 522 to which processor 524 and main memory 526 are connected. Display adapter 528, keypad adapter 530, storage 532, and audio adapter 534 also are connected to bus 522. Cradle link 536 provides a mechanism to connect PDA 500 to a cradle used in synchronizing data in PDA 500 with another data processing system. Further, display adapter 528 also includes a mechanism to receive user input from a stylus when a touch screen display is employed.

An operating system runs on processor 524 and is used to coordinate and provide control of various components within PDA 500 in FIG. 5B. The operating system may be, for example, a commercially available operating system such as Windows CE, which is available from Microsoft Corporation. Instructions for the operating system and applications or programs are located on storage devices, such as storage 532, and may be loaded into main memory 526 for execution by processor 524.

Those of ordinary skill in the art will appreciate that the hardware in FIG. 5B may vary depending on the implementation. Other internal hardware or peripheral devices, such as flash ROM (or equivalent nonvolatile memory) or optical disk drives and the like, may be used in addition to or in place of the hardware depicted in FIG. 5B.

Client machine 300, mobile phone 400, and PDA 500 are presented simply as examples of the various means by which the present invention may be implemented. The present invention may also be implemented using pagers, palm pilots, landline telephone systems, as well as any other device which may be used to enter and/or retrieve information to and from a database.

A primary advantage of the present invention is the ability to store voice messages/memos in a uniform format, which is independent of the input and retrieval devices. In this manner, all messages can be stored in the same database, regardless of the hardware used for input and retrieval of those messages. The use of a single database ensures that all input/retrieval methods are synchronized. Examples of uniform formats that may be used for storing messages/memos in the database include, but are not limited to, MP3, wave (WAV), Windows Media Audio (WMA), Unix AUdio (AU), and Real Audio (RA).

As an example, a user may leave a voice message by using a cellular phone. This message is then stored in the database as an MP3 file. Later, the owner of the account may retrieve the message by means of a personal computer. In this case, the MP3 file would be sent as a data file, which could be displayed as text on the computer screen. Another example could go in the reverse direction: The person leaving the message could use an email text message, which would be converted into MP3 format when stored in the database. If the account owner retrieves the message by using a telephone, the MP3 file is played over the phone as a voice message.

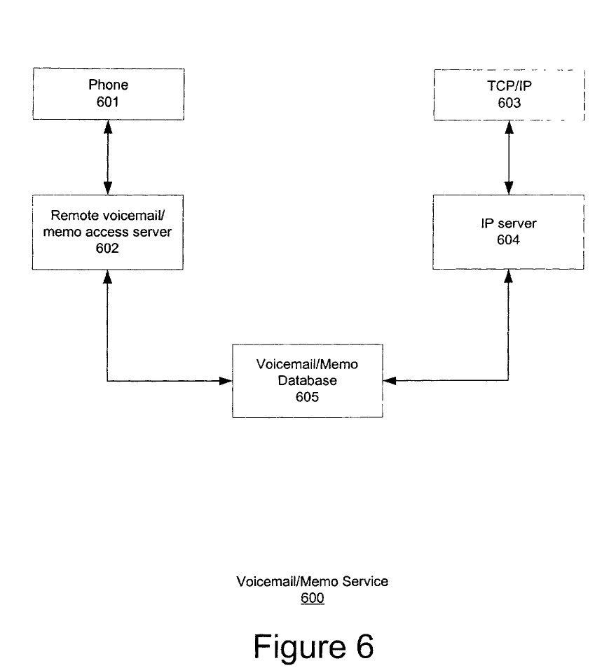

Referring now to FIG. 6, a schematic diagram illustrating a general overview of the architecture of a voicemail/memo service is depicted in accordance with the present invention. The two main methods of entering and retrieving messages/memos are by telephone 601 and TCP/IP 603. Separate remote access servers 602 and 604 are used to access message database 605, depending on the input or retrieval method. In the present invention, both voice and TCP/IP messages/memos are being stored in the same database 605. As explained above, all input and output methods are synchronized because they are all accessing the same message data.

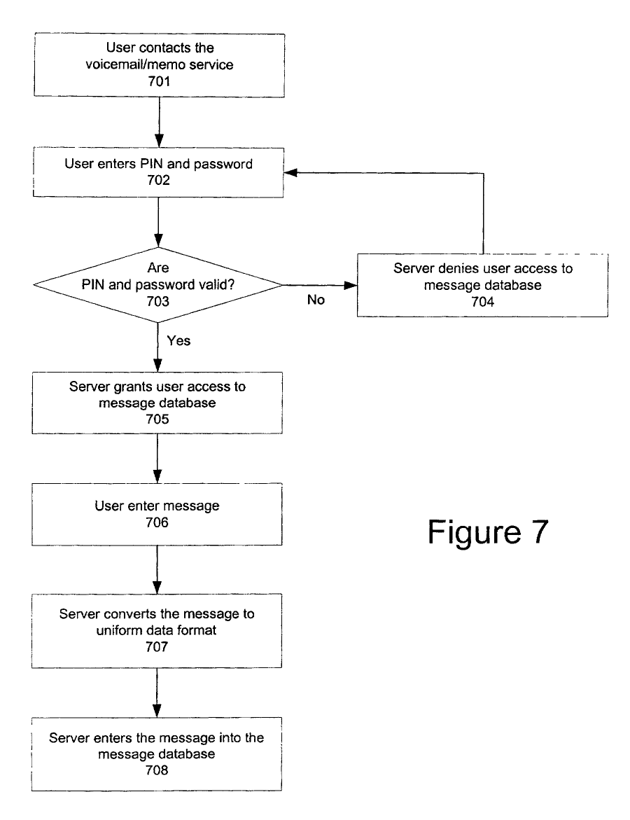

Referring to FIG. 7, a flowchart illustrating the process of recording a voice message/memo is depicted in accordance with the present invention. As explained in reference to FIG. 6, the user may contact the voicemail/memo service by means of telephone or TCP/IP (step 701). If using a telephone (e.g., cell or landline phone), the user calls the voicemail/memo service using a special 1-800 telephone number.

When requested by the automated service, the user enters a personal identification number (PIN), followed by a password (step 702). The remote access server determines if the PIN and password are valid (step 703). If the PIN and/or password are not valid, the remote access server denies access to the message database (step 704), and may allow the caller to enter another PIN and/or password. If the PIN and password entered by the user are valid, the remote access server grants the user access to the message database account which is associated with that PIN (step 705). The user then enters a message (step 706). The message may be a voice message by means of telephone or voice-over-IP. Alternatively, the user may enter a IP text message. Regardless of the method of input, the remote access server converts the message into a uniform data format, which has been specified for that account or database (step 707). As explained above, there are several formats, such as MP3 and wave, which may be used as the uniform format. In addition, if the specified uniform format is the same as the format used by the input device, then there is not need to perform the conversion in step 707. After the message has been converted to the specified uniform format (if necessary), the server enters the message into the message database (step 707).

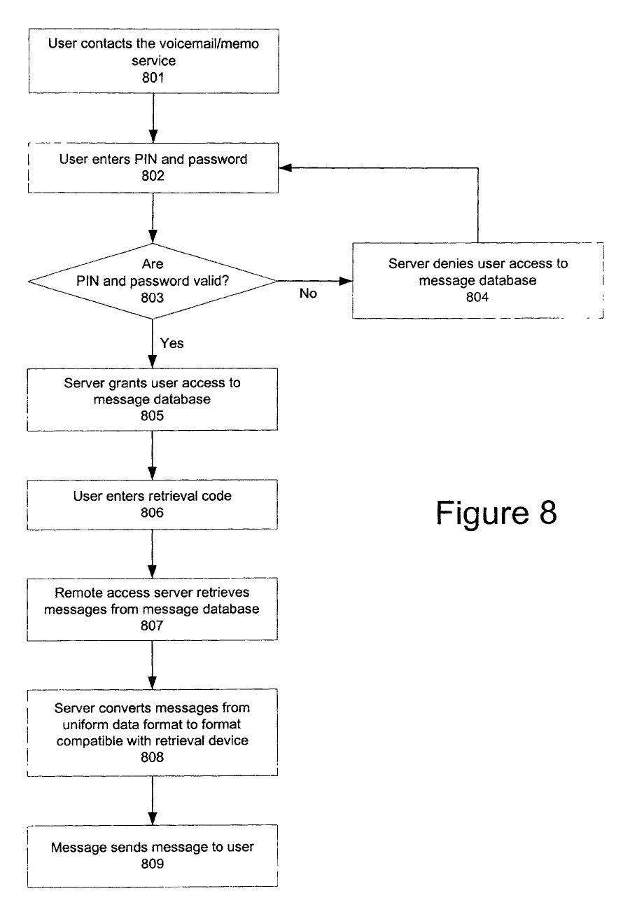

Referring now to FIG. 8, a flowchart illustrating the retrieval of voicemail/memos is depicted in accordance with the present invention. Similar to FIG. 7, the user contacts the voicemail/memo service (step 801) and enters a PIN and password when requested by the system (step 802). The remote access server determines if the PIN and are valid (step 803). If the PIN and/or password are not valid, the remote access server denies the user access to the message database (step 804). The user may enter another PIN and/or password.

If the PIN is valid, the remote access server grants the user access to the message database account associated with that PIN (step 805). The user then enters a special message retrieval code (step 806), and the remote access server retrieves messages from the database and determines the method by which the user is accessing the database (e.g., phone or computer) (step 807). The server then converts the messages from the uniform storage format into a data format that is compatible with the retrieval device (step 808). (As with step 707, it might not be necessary to convert the message data into another format.) The message data is then sent in the appropriate format to the user's retrieval device (step 809).

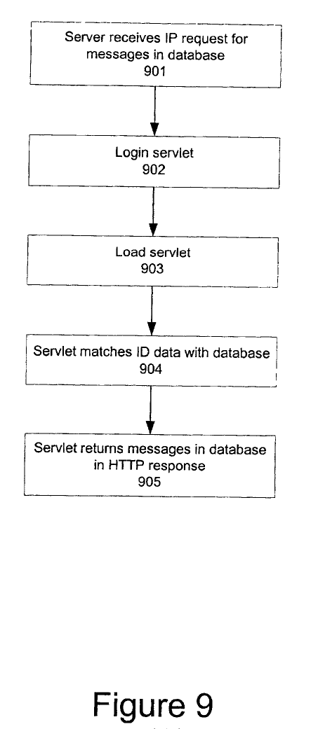

Referring to FIG. 9, a flowchart illustrating the use of Common Gateway Interface to access voicemail via TCP/IP is depicted in accordance with the present invention. The methodology presented in the present example is Java-based. However, it should be noted that other architectures, utilizing different technologies, may be used to implement the present invention. After the IP server receives an IP request for access to the message database (step 901), the user logs in a special servlet (step 902). An authentication servlet is then loaded (step 903). This servlet matches ID data (i.e. PIN) with an account in the database (step 904). When messages are retrieved from the database, the servlet returns the messages in an HTTP response (step 905). The servlet uses Java database connectivity (JDBC) to access the database. JDBC is a Java application program interface (API), which is a language and message format that is used by an application program to communicate with the operating system or some other control program, such as a database management system (DBMS).

While different methods (i.e. phone, computer) may be used to enter and retrieve message, it should be emphasized that the data in the message database is stored in a uniform format. This uniform storage format is then converted depending on the method of retrieval, as explained above. Converting voice and TCP/IP messages into a uniform storage format allows the user to access both voice messages and text messages from the same service, thus providing the user with “one stop shopping”.

The present invention may also be used to leave public messages for selected third parties. For example, the account holder may wish to leave a detailed message for a group of friends or colleagues. The account holder may leave the message and then provide specific people with the necessary PIN and password. The user would most likely set up a separate public account for this purpose, in order to prevent unwanted access of personal messages and memos.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for entering messages into a database, the method comprising:
receiving a message from a user by means of one of a plurality of allowable communication devices;
entering the message into a designated account in the database; and
storing the message in a uniform storage format specified for the account, wherein the uniform storage format is independent of a data format used by the communication device.

2. The method according to claim 1, wherein the allowable communication devices include:
telephone;
mobile telephone;
computer
PDA; and
pager.

3. The method according to claim 1, further comprising requesting personal identification information from the user, wherein the information is used to verify access rights to the database.

4. The method according to claim 1, wherein the message entered into the database is a voice message.

5. The method according to claim 1, wherein the message entered into the database is a text message.

6. The method according to claim 1, wherein the uniform storage format specified for the database account may be one of the following:
MP3;
wave file;
AU;
WMA; and
Real Audio.

7. A method for retrieving messages from a database, the method comprising:
receiving a message-retrieval request from a user by means of one of a plurality of allowable communication devices;
retrieving the requested message from a designated account in the database, wherein the message is stored in a uniform storage format specified for the account;
converting the message contents from the uniform storage format to a data format compatible with the communication device; and
conveying the message contents to the user.

8. The method according to claim 7, wherein the allowable communication devices include:
telephone;
mobile telephone;
computer
PDA; and
pager.

9. The method according to claim 7, further comprising requesting personal identification information from the user, wherein the information is used to verify access rights to the database.

10. The method according to claim 7, wherein the message retrieved from the database is a voice message.

11. The method according to claim 7, wherein the message retrieved from the database is a text message.

12. The method according to claim 7, wherein the uniform storage format specified for the database account may be one of the following:
MP3;
wave file;
AU;
WMA; and
Real Audio.

13. A computer program product in a computer readable medium for use in a data processing system, for entering messages into a database, the computer program product comprising:
instructions for receiving a message from a user by means of one of a plurality of allowable communication devices;
instructions for entering the message into a designated account in the database; and
instructions for storing the message in a uniform storage format specified for the account, wherein the uniform storage format is independent of a data format used by the communication device.

14. The computer program product according to claim 13, wherein the allowable communication devices include:
telephone;
mobile telephone;
computer
PDA; and
pager.

15. The computer program product according to claim 13, further comprising instructions for requesting personal identification information from the user, wherein the information is used to verify access rights to the database.

16. The computer program product according to claim 13, wherein the message entered into the database is a voice message.

17. The computer program product according to claim 13, wherein the message entered into the database is a text message.

18. The computer program product according to claim 13, wherein the uniform storage format specified for the database account may be one of the following:
MP3;
wave file;
AU;
WMA; and
Real Audio.

19. A computer program product in a computer readable medium for use in a data processing system, for retrieving messages from a database, the computer program product comprising:
instructions for receiving a message-retrieval request from a user by means of one of a plurality of allowable communication devices;
instructions for retrieving the requested message from a designated account in the database, wherein the message is stored in a uniform storage format specified for the account;
instructions for converting the message contents from the uniform storage format to a data format compatible with the communication device; and
instructions for conveying the message contents to the user.

20. The computer program product according to claim 19, wherein the allowable communication devices include:
telephone;
mobile telephone;
computer
PDA;
pager; and
palm computer

21. The computer program product according to claim 19, further comprising instructions for requesting personal identification information from the user, wherein the information is used to verify access rights to the database.

22. The computer program product according to claim 19, wherein the message retrieved from the database is a voice message.

23. The computer program product according to claim 19, wherein the message retrieved from the database is a text message.

24. The computer program product according to claim 19, wherein the uniform storage format specified for the database account may be one of the following:
MP3;
wave file;
AU;
WMA; and
Real Audio.

25. A system for entering messages into a database, the system comprising:
a receiver adapted to receive a message from a user by means of one of a plurality of allowable communication devices;
a filing component adapted to enter the message into a designated account in the database; and
a storage component adapted to store the message in a uniform storage format specified for the account,
wherein the uniform storage format is independent of a data format used by the communication device.

26. A system for retrieving messages from a database, the system comprising:
a receiver adapted to receive a message-retrieval request from a user by means of one of a plurality of allowable communication devices;
a retrieving component adapted to retrieve the requested message from a designated account in the database, wherein the message is stored in a uniform storage format specified for the account;
a conversion component adapted to convert the message contents from the uniform storage format to a data format compatible with the communication device; and
a conveyance component adapted to convey the message contents to the user.
